(19) United States
(12) Patent Application Publication
(10) Pub. No.: US 2007/0045183 A1
(43) Pub. Date: Mar. 1, 2007

(54) Purified water reclamation process

(76) Inventor: Dee Thomas Murphy, Sparks, NV (US)

Correspondence Address: Dee Thomas Murphy, 7630 Tholl Drive, Sparks, NV, 89506, US

(21) Appl. No.: 11/510,935

(22) Filed: Aug. 28, 2006

Related U.S. Application Data
(60) Provisional application No. 60/711,981, filed on Aug. 26, 2005.

(51) Int. Cl. C02F 3/00

(52) U.S. Cl. 210/631

(57) ABSTRACT

A hybrid alternative water reclamation process for producing and re-using purified water including use of a biological non-compartmented reactor basin having multiple prior art patented Omni-flow partitions in combination with an optional patented I.V.E Collector, and when combined with UF/RO “ULTRA FILTRATION and REVERSE OSMOSIS” provides double barrier treated drinking water that complies with NSF International certified water standards #61 and #58.

### RELATED PRIOR ART

This application is derived from my provisional application No. 60/711,981, which was filed on Aug. 26, 2005 in the name of the current inventor. It is to be noted no new material has been entered. The application as presented herein has just been reformatted to comply with PTO regulations. Also, the certificate of mailing is dated Aug. 28, 2006 because the 26^{th} was a Saturday, thus the application is timely filed accordingly.

### FIELD OF THE INVENTION

The present invention relates in general to a hybrid alternative wastewater treatment processes but more particularly pertains to water reclamation processes that are used for purifying and completely recycling wastewater for re-use in a new simplified improved environmentally friendly manner and is more economically achievable than other inferior options currently available. The process eliminates numerous components currently associated with such systems and this proves to be most advantageous and very cost effective. The process includes use of my previously patented technology and when combined in combination with UF/RO “ULTRA FILTRATION/REVERSE OSMOSIS” type of physical filtration technology provides most unusual results heretofore not attained. Namely, the present process provides as an end result double barrier treated drinking water that complies with NSF International certified water standards #61 and #58 and thus accomplishing new unusual results not attained within the known prior art.

### BACKGROUND OF THE INVENTION

As previously noted, the present system/process incorporates technologies in combination including my prior art patents. Namely, U.S. Pat. Nos. 5,186,821, 5,234,580, 5,316,671, 5,352,356, 5,374,353 and 5,384,049. Also included as an option is my currently patent pending application No. 60/700,270 entitled ‘A PROCESS/METHOD AND APPARATUS FOR RECOVERING ENERGY FROM TURBULENCE CREATED WITHIN AN AEROBIC-BIOLOGICAL-REACTOR.

Within the known prior art there have been numerous attempts to provide improved wastewater management systems and/or processes. For example some prior art patents include U.S. Pat. No. 6,159,380 entitled “WATER TREATMENT PROCESS”, U.S. Pat. No. 6,103,125 entitled “ZERO WASTE EFFLUENT WATER DESALINATION SYSTEM” and U.S. Pat. No. 6,641,721 entitled “PROCESS AND APPARATUS FOR TREATING WASTEWATER”. However, each system has inherent disadvantages and drawbacks that the present invention recognizes, addresses and resolves in a novel manner heretofore not taught. Most all of the prior art is very complicated and each are only functional with highly expensive problematical components all of which the present invention completely eliminates. Also, the prior art only produces treated wastewater effluent for disposal, not purified water having no pollutants, suitable for all uses of water including drinking. It is known to purify (eliminate all pollutants known to be harmful to human health) water through a variety of commercially available water reclamation devices designed for point-of-use applications in the commercial/residential/industrial water treatment market. The most popular methods are based on the following technologies: activated carbon for organic removal: ultraviolet light disinfection: ion exchange for hardness removal (water softening), micro filtration and membrane desalination such as (UF) ultra filtration or reverse osmosis (RO) or nanofiltration (NF).

Membrane filtration has been used for over two decades now. Generally speaking, membrane filtration used for residential and commercial water treatment applications can remove all dissolved solids by approximately 98%. This type of filtration has proven to be very beneficial but has certain limitations, namely due to the fact that such systems are intermittent and this does not permit for continuous on-demand water supply. As a result there has not been a functional satisfactory efficient and cost effective process available until now that would be functional for wastewater treatment, now known as purified water reclamation (PWR), using prior art with (UF/RO) technology and as a result provides reclaimed purified drinking water that complies with NSF certified water standards. This quality of water consistently meets the maximum contaminate level goals (MCLG's) determined by the United States Environmental Protection Agency (USEPA). These levels of water quality are unenforceable by law, therefore no ‘discharge’ permit is required as there is ‘no addition of a pollutant’ associated with the reclaimed pure water which is produced.

The most pertinent prior art is taught within my U.S. Pat. No. 5,186,821 which accomplishes new and unusual results due to the novel “IVEC” (Influent Velocity Equalization Collector) AND “OMNI FLOW PARTITION” as taught within my U.S. Pat. Nos. 5,384,049, 5,374,353 and 5,316,671 each of which are utilized within the present invention.

### OBJECTS AND ADVANTAGES

It is therefore a primary object of the present invention to provide the most highly advanced purified water reclamation process possible with today's technologies and thus overcome the disadvantages and costly drawbacks associated within all of the known prior art.

It is another object of the present invention to provide a purified water reclamation process that is not limited in use, as it is functional for residential, commercial, industrial and municipal use.

Still a further object is to provide the best purified water reclamation process as described in the Clean Water Act (CWA), the Federal Law, defined in the United States Code, Title 33, Chapter 26, Section 1251 et. Seq. and more specifically as defined in Section 1316 which references the Best Available Demonstrated Control Technology (BADCT)) that eliminates waste of water (zero wastewater) and this heretofore has not been efficiently or cost effectively achieved until now with this present technology as taught herein.

Yet another very important object of the present invention is to provide a purified water reclamation process that complies with all current federal and state codes. Namely, the present process achieves a “Standard of Performance” as required by the U.S. Code, Title 33, Chapter 26, Subchapter III, Sec. 1316.—National standard of performance, (a)(1), the term “standard of performance” means a standard for the control of the discharge of pollutants which reflect the greatest degree of effluent reduction which the Administrator (EPA) determines to be achievable through application of the best available demonstrated control technology, processes, operating methods, or other alternatives, including, where practicable, a standard permitting no discharge of pollutants. The standard of performance established by this process is purified drinking water permitting no discharge of pollutants, the standard required by Federal Law (CWA) if available to the entire industry, this technology is as it is suited for a single family dwelling up to a multi-million gallon per day municipal plant including commercial and industrial.

Still another object of the present invention is to provide a purified water reclamation process that is an advanced hybrid alternative of the Conventional Extended Aeration System, Intermittent Cycle Extended Aeration System (ICEAS), the Sequential Batch Reactor (SBR) technologies, and the Membrane Biological Reactor (MBR) and additionally incorporates advanced alternative techniques which sets it apart from all other available innovative technologies when compared as defined and required in the Federal Clean Water Act, 33 U.S.C § 1251 et seq. The process is to be applied where pollution abatement or purified water reclamation from a waste stream or any other water stream having a pollutant or pollutants is required by the best available technology where high strength domestic and industrial waste with high peak flow variations require a flexible, low-cost, dependable, system that unquestionably and reliably produces a consistent high-quality “effluent” which in this case is qualified as NSF International/ANSI certified treated drinking water quality that meets the NSF International standards #61 and #58.

The quality of water (reclaimed purified treated drinking water) produced from this process is superior to that obtained from conventional wastewater treatment facilities. The quality of the water produced with this process meets the maximum containment level goals (MCLGS) established by the EPA which have no pollutant levels that are known to be harmful to public health. Thus “The Best Practicable Waste Treatment Technology” [U.S.C. 33, Sec. § 1281 (g) (A)] description references the present process and this heretofore has not been attainable.

Also, a further object of the present invention is to provide a purified water reclamation process that incorporates continuous feed activated sludge technology with intermittent cyclic system operation requiring only a single reactor basin. The process uses a single tank (multiple reactor basins are also an option) in which the activated sludge is aerated over a number of pre-determined cycles. Solids/liquid separation occurs during the air-off part of the cycle allowing for denitrification to naturally occur via the patented IVE Collector (optional) that works in conjunction with my patented Omni-Flow partition and a second modified Post Omni-Flow partition. Denitrification occurs during the air-off phase of the aeration cycle selected continuing during the initial period of the aeration phase following aeration phase startup. During the air-off phases of the aeration cycle, the biomass settles in the lower portion of the reactor basin where it becomes a natural biological filter. As the raw influent enters into the reactor, controlled by the IVE Collector, first splash energy is mitigated, then, the raw influent is directed downward through the settled biomass blanket via the Omni Flow partition where denitrification occurs naturally without the use of mixers, or separate anoxic chamber as required in all other systems. The UF/RO membrane component in conjunction with my patented IVE Collector, my patented Omni-Flow partition and a second modified Post Omni-Flow partition which as taught herein, allows for disinfection, liquid/solids separation (clarification), resulting in producing a reliable reclaimed purified treated drinking water, the guaranteed quality of which is; 100% removal of colloids and particulates larger than 10 nano meters, turbidity less than 0.1 NTU, over log 6 removal of bacteria (99.9999% removal), over log 4 removal of viruses (99.99% removal) and removal of large molecular weight organic compounds (above 100,000 Daltons).

Because of the unique patented influent hydraulic control features of the process, influent inflow is continuously accommodated through all phases of the single pole operation cycle. In this way, the functions of flow equalization, biological oxidation, nitrification, denitrification, secondary sedimentation, clarification, (micro filtration, UV disinfection and ozone disinfection are optional) and aerobic sludge digestion are all carried out in a single vessel. The duration of a process cycle is specific to each design application and variable in the field as required.

Yet another object of the present invention is to provide a purified water reclamation process that is “The Best Practicable Control Technology Currently Available” (BPT), the present invention, is the best available “possible to practice or perform” (“practicable” means possible) waste treatment technology as it consistently produces the greatest degree of reduction of pollutants (conventional and toxic) when compared to all other available waste treatment and/or water reclamation process technologies.

It is to be understood, “The Most Cost Effective Alternative”; is to be determined by comparing three (3) different areas of cost, capital costs associated with the initial purchase and installation of the treatment works, the ongoing operating costs related to energy requirements, and the ongoing cost associated with the operating and maintenance of the treatment works. Title 33 U.S.C § 1298.—“Cost effectiveness” (a) Congressional statement of policy, states “It is the policy of Congress that a project for waste treatment and management undertaken with Federal financial assistance under this chapter by any State, municipality, or intermunicipality, or intermunicipal or interstate agency shall be considered as an overall waste treatment system for waste treatment and management, and shall be that system which constitutes the most economical and cost-effective combination of devices and systems used in the storage, treatment, recycling, and reclamation of municipal sewage or industrial wastes of a liquid nature to implement section 1281 of this title, or necessary to recycle or reuse water at the most economical cost over the estimated life of the works, including intercepting sewers, outfall sewers, sewage collection systems, pumping power, and other equipment, and their appurtenances; extension, improvements, remodeling, additions, and alterations thereof; elements essential to provide a reliable recycled supply such as standby treatment units and clear well facilities; and any works, including site acquisition of the land that will be an integral part of the treatment process (including land use for the storage of treated wastewater in land treatment systems prior to land application) or which is used for ultimate disposal of residues resulting from such treatment; water efficiency measures and devices; and any other method or system for preventing, abating, reducing, storing, treating, separating, or disposing of municipal waste, including storm water runoff, or industrial waste, including waste in combined storm water and sanitary sewer systems; to meet the requirements of this chapter.” The present invention/process is the least costly pollution abatement solution in regard to capital costs, energy consumption, and ongoing operation and maintenance requirements as compared to all other comparable alternatives, in many cases, by more than 50%. The energy requirements of the single basin process having only a single pole control requires no additional equipment for mixing or re-circulation of the mixed liquor, along with eliminating the need for external tertiary filters or clarifiers to purchase, operate and maintain, makes this invention/process the most energy efficient “0”pollutant “0”discharge alternative available. The “value engineering” premise of the present invention/process eliminates the unnecessary high costs of each project in order to arrive at a cost savings without sacrificing the reliability or efficiency of the project. [33 U.S.C. § 1292 (2) (B) & 33 U.S.C. § 1298]

Yet a very important object of the present invention is to provide a purified water reclamation process that prevents exposure to any pollutant that is known to be harmful to human health or the environment and is therefore a homeland security protection solution which is most advantageous, resulting in reclaiming purified treated water at its source.

Still another important object of the present invention is to include optional components that further enhance the overall performance of the present process and again provide new and unusual end results heretofore not achieved. For example, I include within the process a flash incinerator that completely destroys any and all pollutants (such as sludge and the like) and results in zero pollution in an environmentally friendly manner.

Also, another object of the present invention is to include another optional component within the process that is a means for recovering energy from within the aerobic biological reactor basin to renew the primary resource consumed, namely electricity, such as taught within my co-pending application No. 60/700,270.

Yet another object of the present invention is to include another optional component such as a de-ionizer that is most advantageous as any and all total dissolved solids/salts due to chemical reaction are naturally converted into chlorine that can be returned to the reactor and further provides new and unusual results.

Other objects and advantages will be seen when taken into consideration with the following specification and drawing.

### BRIEF DESCRIPTION OF THE DRAWING

FIG. 1 is a general overview for the preferred process of the present invention.

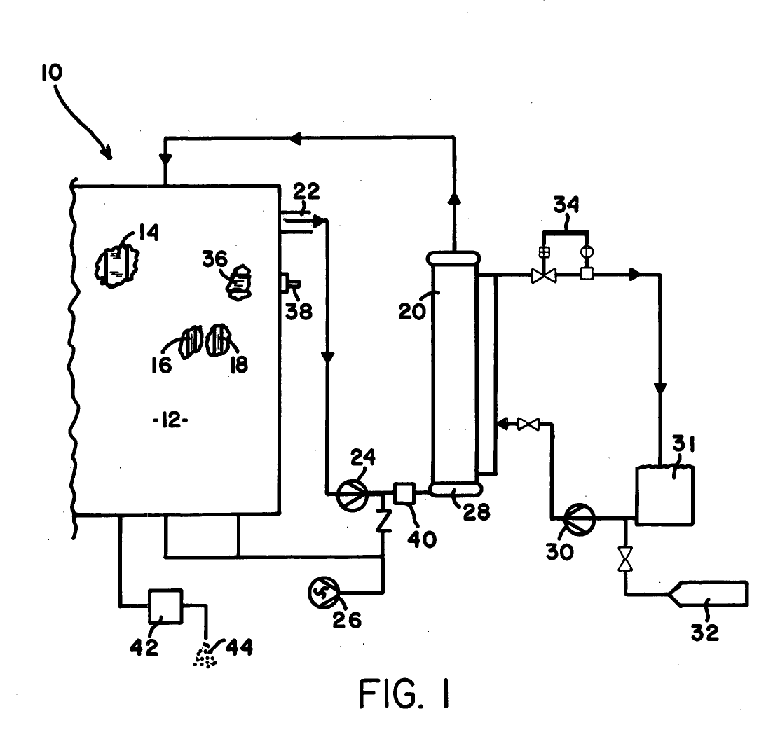

### DETAILED DESCRIPTION OF THE DRAWING

Referring now in general to the drawing wherein like characters refer to like elements therein. The general process of the present invention accomplishes the most unusual new end results namely due the use of my prior art patented omni-flow partition as disclosed in U.S. Pat. No. 5,384,049 when combined with a second post omni-flow partition and/or the process may include as an option my patented I.V.E. Collector as disclosed in U.S. Pat. No. 5,186,821 and thus the actual working of each are not taught herein, as the present invention is, in part, the process and not the apparatus respectively as follows:

The present purified water reclamator process substantially including use of a typical purified water reclamation system (10) having a biological reactor basin (12) that is not compartmented and has inherent complete mix, nitrifies, denitrifies, clarifies, provides suspended growth biological treatment followed by at a minimum, one physical treatment step resulting in producing purified water suitable for drinking, and having no pollutants which exceed the MCLGs, and which meets the quality criteria as defined in the International Treated Drinking Water established Standards known industry wide as NSF Standard 61 and 58.

The biological reactor basin (12) includes the IVE collector (14) (which is optional) and the typical omni-flow partition (16) as taught within the prior art and a second post omni-flow partition (18) that is herein considered new. The main modification to the second post omni-flow partition is that the inlet for effluent is located on the bottom of the partition as opposed to the inlet on the typical omni-flow partition (16) that is located on the top of the partition respectively. Whereby the second post omni-flow partition (18) provides novel new results as this embodiment allows for liquid/solids separation during the aeration of the biological reactor basin contents and also eliminates the need for a decanter. Therefore, the clarified effluent can be easily drawn from the top of the second post omni-flow partition (18) via outlet (22) and then delivered to the ultra diffuser (28) of the filtration reverse osmosis type membrane (20) for final reclamation. It is to be noted the ultra filtration reverse osmosis type membrane (20) is typical having standard associated components including a feed pump (24), a compressor or blower (26), a diffuser (28), a back pulse pump (30), a chemical basin (31) to assist backwash, a chemical feed means (32), and a filtrate flow control means (34). It is to be noted the actual workings of the above components are not taught herein as such is well known within the art.

As previously noted the present process may include additional optional components that provide further increased performance and new and novel end results. For example, the process may also include a renewable hydropower recovery means (36) having free rotating rod(s) (38) that are used to transfer rotational energy there from that can be used for energizing a typical generator or the like. The actual workings of the renewable hydropower recovery means are not taught herein as they are defined and taught within my co-pending application No. 60/700,270.

A further optional feature of the present invention is to include a deionizer (40) which is most advantageous as this allows for any and all total dissolved solids/salts (TDS) “due to chemical reaction” to be naturally converted into chlorine that can be returned to the biological reactor basin (12) and thus further provides new and unusual results.

Yet a further optional feature of the present invention is to include a novel flash incinerator (42) that is again very advantageous as this completely destroys any and all pollutants (such as sludge and the like) and results in zero pollution in an environmentally friendly manner. The flash incinerator (42) not only eliminates all pollutants but will also convert the pollutants into a fine fly ash (44) that is usable for safe environmental purposes.

Thus, the purified water reclamation system (10) following the known physical treatment level of the ultra filtration reverse osmosis type membrane (20) provides purified drinking water, as defined by international standards, in a new and improved manner heretofore not taught within the known prior art.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described the invention, what I claim as new and desire to secure by LETTERS PATENT is:

1. A purified water reclamator process comprising: a true single basin biological reactor that provides complete mix, inherent flow equalization and eliminates the need for a sludge return pumping system and said biological reactor true single basin, nitrifies, denitrifies, clarifies and purifies and includes submerged spiral wound membrane technology to provide guaranteed integrity against fiber breaking as with hollow fiber membrane technology and at a minimum, will provide suspended growth biological treatment followed by, one physical treatment step resulting in producing purified water suitable for drinking, having no pollutants which exceed the MCLGs, and which meets the quality criteria as defined in the International Treated Drinking Water established Standards known industry wide as NSF Standard 61 and 58.

2. The true single basin biological reactor of claim 1 further includes as an option an IVE collector; a first omni-flow partition; and a second post omni-flow partition, said IVE collector, said first omni-flow partition and said second post omni-flow partition in combination provide denitrification within said biological reactor true single basin without anoxic chambers, said second post omni-flow partition having an inlet for effluent located on the bottom as opposed to an inlet located on the top, whereby, said second post omni-flow partition allows for liquid/solids separation during the aeration of said true single basin biological reactor contents resulting in elimination of a floating decanter, whereby, clarified effluent can be easily drawn from the top of said second post omni-flow partition via a submerged spiral membrane outlet and then delivered to a reverse osmosis type membrane for final reclamation, said membrane of the filtration reverse osmosis type membrane includes a feed pump; a compressor or blower; a diffuser; a back pulse pump; a chemical basin to assist backwash; a chemical feed means; and a filtrate flow control means.

3. The biological reactor true single basin of claim 2 further includes as an option a renewable hydropower recovery means having free rotating rod(s) that are used to transfer rotational energy there from that can be used for energizing a generator.

4. The true single basin biological reactor of claim 1 further includes as an option a deionizer which is most advantageous as this allows for any and all total dissolved solids/salts (TDS) due to chemical reaction to be naturally converted into chlorine that can be returned to said biological reactor true single basin resulting in new end results.

5. The true single basin biological reactor of claim 1 further includes as an option a flash incinerator that is again very advantageous as this completely destroys any and all pollutants including sludge and results in zero pollution in an environmentally friendly manner, said flash incinerator not only eliminates all pollutants but will also convert said pollutants into a fine fly ash that is usable for safe environmental purposes.
